(19) United States
(12) Patent Application Publication
(10) Pub. No.: US 2007/0140396 A1
(43) Pub. Date: Jun. 21, 2007

(54) METHOD FOR PREVENTING FREQUENCY DISTORTION IN A MULTIMODE SYSTEM AND THE SYSTEM THEREOF

(75) Inventor: Tung Feng Yang, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/612,401

(22) Filed: Dec. 18, 2006

(30) Foreign Application Priority Data
Dec. 19, 2005 (TW) TW94145037

(51) Int. Cl. H04L 7/04

(52) U.S. Cl. 375/362

(57) ABSTRACT

A method for preventing frequency distortion in a multimode system which includes a main device, a subordinate device, a control circuit and a clock generator. The main device generates a main clock enable signal and a main frequency control signal. The subordinate device generates a sub clock enable signal. The control circuit generates a frequency control signal and a clock generator enable signal according to the main clock enable signal, sub clock enable signal and the main frequency control signal. The clock generator generates a main clock signal and a sub clock according to the clock generator enable signal and the frequency control signal.

### BACKGROUND OF THE INVENTION

Field of the Invention

The invention is related to clock generation, and more particularly to techniques for generating multiple clock signals.

Wireless communication technology has grown rapidly. Many wireless communication systems, such as GSM, are popular. The development trend of mobile phones is toward a highly integrated design, for example, a device which is compatible with GSM, blue-tooth, wireless LAN, and others. Typically, clock generation for dual mode (GSM and blue-tooth) systems is performed by individual clocks for both GSM and blue-tooth or single wherein GSM and blue-tooth share one clock.

FIG. 1 shows a block diagram of which a main device 12 and a subordinate device 14 each individually generate their own clock, clk 1 and clk 2. In FIG. 1, the main device 12 may be a GSM transceiver, and the subordinate device 14 may be a blue-tooth or wireless LAN transceiver. Since each transceiver needs its own clock, two clock generators 16 and 18 are required. In other words, two controllable oscillators are required in each clock generator, which increases cost.

The block diagram FIG. 2 shows one clock shared by the main and subordinate devices. In many systems, the clock generator employed is inadequate.

The frequency generated by an inadequate clock generator and frequency required by the system has frequent errors. The tolerance of clock error in a wireless communication system varies according to the communication distance and network complexity. To control the frequency error, a frequency control unit is required. In FIG. 2, only the main device possesses frequency control unit 26. Frequency control unit 26 sends a frequency control signal (V_{fc}) to the voltage controlled oscillator 28 so that the voltage controlled oscillator 28 can generate different main clock clk_1 frequencies according to different levels of frequency control signal V_{fc}. When the subordinate device 24 requires a sub clock clk_2, a clock request signal (req) is sent to the main device 22. Typically, when the main device 22 is idle, the frequency control unit 26 inside shuts-down. The clock signal generated by the voltage-controlled oscillator 28 not adjusted by a closed loop consists of 28 and 22, thus the main clock clk_1 and sub clock clk_2 are unstable. In this way, the frequency of clock signals is distorted. If the subordinate device 24 is activated, the unstable clock frequency of subordinate device 24 would let the subordinate device 24 fail to synchronize with the communication network, and thus the subordinate device 24 is unable to access the network. In this way, when the subordinate device needs a sub clock clk_2 and the main device 22 is idle, the subordinate device 24 will transmits a clock request signal to the main device to activate the main device 22. In other words, when the subordinate device 24 needs a sub clock signal, the main device 22 must wake up, which increases the power consumption of the system.

### BRIEF SUMMARY OF THE INVENTION

Accordingly, methods efficiently providing multiple clock signals for a multimode system and the multimode system thereof are provided. The multimode system for preventing frequency distortion comprises a main device, a subordinate device, a control circuit, and a clock generator. When activated, the main device generates a main clock enable signal and a main frequency control signal. The subordinate device generates a sub clock enable signal when the subordinate device is activated. The control circuit receives the main clock enable signal, the sub clock enable signal, and the main frequency control signal, and outputs a clock generator enable signal and a frequency control signal. When either the main device or the subordinate device turns on, the clock generator is activated and generates a clock signal to the activated device.

In one aspect of the invention, the clock generator further comprises a frequency divider. The frequency divider produces clock signals with varied frequency to meet the system requirement.

In another aspect of the invention, the clock generator further comprises a controllable oscillator. The controllable oscillator may be a voltage controlled oscillator. The voltage controlled oscillator generates oscillating signals with varied frequencies according to the input voltage level.

In yet another aspect of the invention, main device is a Global System for Mobile Communications (GSM) system, and the subordinate device is a blue-tooth or 802.11a/b/g transceiver.

A method for preventing frequency distortion is also provided. The method is applied to a multimode system which comprises a main device, a subordinate device, a control circuit and a clock generator. The method comprises the main device sending a main clock enable signal and a main frequency control signal. The subordinate device also sends a sub clock enable signal when activated. A clock generator enable signal is generated according to the main clock enable signal and the sub clock enable signal, and a frequency control signal according to the main clock enable signal and the main frequency control signal is generated. A main clock signal is generated when the main device is activated, and a sub clock signal is generated when the subordinate device is activated.

### BRIEF DESCRIPTION OF THE DRAWINGS

The invention will become more fully understood from the detailed description, given herein below, and the accompanying drawings. The drawings and description are provided for purposes of illustration only, and, thus, are not intended to be limiting of the invention.

FIG. 1 is a block diagram of which a main device and a subordinate device each individually generating its own clock;

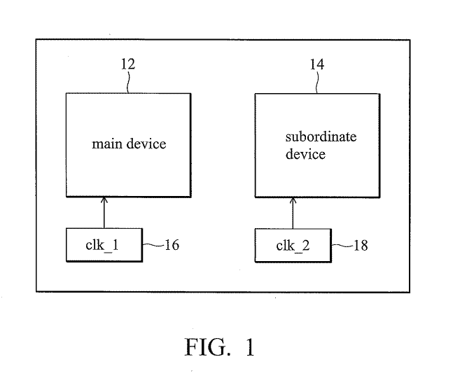

FIG. 2 is a block diagram showing one clock signal shared by the main and subordinate devices;

FIG. 3 shows a multimode system for preventing frequency distortion; and

FIG. 4 shows a flowchart of a method for preventing frequency distortion in a multimode system.

### DETAILED DESCRIPTION OF THE INVENTION

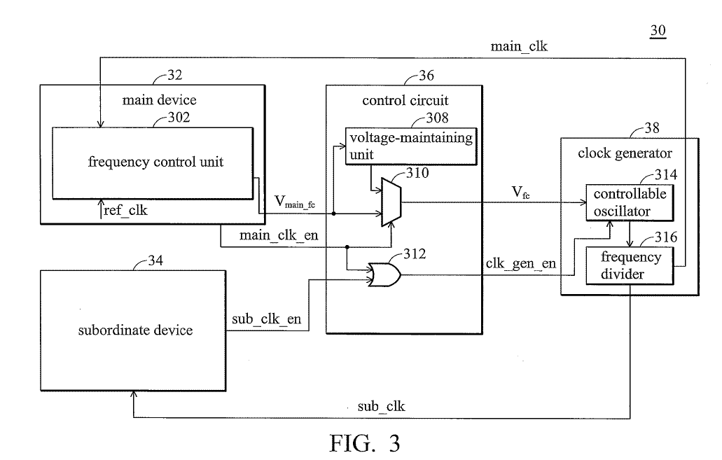

FIG. 3 shows a multimode system 30 for preventing frequency distortion. In this embodiment of the invention, the multimode system is applied to prevent clock signal distortion; however, the invention is not limited thereto. In other embodiments of the invention, the multimode system can control any signal requiring regular frequencies. The multimode system 30 comprises a main device 32, subordinate device 34, control circuit 36, and a clock generator 38. The main device 32 comprises a frequency control unit 302. The frequency control units 302 generates a main frequency control signal (Vₘₐᵢₙ_{_{—}}_{fc}), and receives a reference clock signal (ref_clk). The reference clock signal can be an external clock signal for synchronization. For example, the main device 32 is a global system for mobile communication (GSM) system, thus, the main device is able to receive a GSM clock as the reference clock signal from a base station of a GSM network. The main device 32 further generates a main clock enable signal (main_clk_en) when the main device 32 is activated. The subordinate device 34 generates a sub clock enable signal (sub_clk_en) when the subordinate device 34 is activated. The control circuit 36 receives the main clock enable signal and the sub clock enable signal to generate a clock generator enable signal (clk_gen_en) accordingly. When either the main or sub clock enable signal is activated, the control circuit 36 activates the clock enable signal. The control circuit 36 also generates a frequency control signal (V_{fc}) according to the main frequency control signal and the main clock enable signal and the main frequency control signal. When the main device 32 is activated, the control unit 36 outputs the main frequency control signal as the frequency control signal. The control unit 36 also keeps the voltage level of the main frequency control signal. As the main device 32 is idling and the subordinate device is activated, the control circuit outputs a signal having same voltage level with the main frequency control signal as the frequency control signal. The clock generator 38 generates a main clock signal (main_clk) when the main device 32 is activated, and generates a sub clock signal (sub_clock) when the subordinate device 34 is activated.

In one embodiment of the invention, the control circuit 36 comprises an OR gate 312, a voltage-maintaining unit 308, and a multiplexer 310. OR gate 312 receives the main clock enable signal and the sub clock enable signal. When either the main clock enable or sub clock enable signal is logic high, the OR gate 213 outputs a signal with logic high to the clock generator. In other words, when the main device or the subordinate device is activated, the frequency control signal is output to the clock generator. In this embodiment of the invention, the main/sub clock enable signal at logic high indicates that the main/subordinate device is activated, and logic low of the main clock enable signal indicates that the main device is disable. In other embodiments of the invention, logic low of the main/sub clock enable signal indicates that the status of the main/subordinate device is activated, and the OR gate is switched to the other logic gate to implement the same function. The voltage-maintaining unit 308 maintains the voltage level of the main frequency control signal. When the main device 32 is idling, the unit inside main device, such as frequency control unit 302, is disabled temporarily, and the main device 32 stops outputting the main frequency control signal. The voltage-maintaining unit 308 outputs the frequency control signal to the clock generator when the main device 32 is idling. The voltage-maintaining unit 308 may be implemented by connecting a resistor and a capacitor in series, or a high order circuit consisting of resistors and capacitors. The multiplexer 310 receives the main frequency control and the maintained voltage level, and selects one of its inputs as an output according to the main clock enable signal. When the main clock enable signal is activated, the multiplexer 310 outputs the main frequency control signal as the frequency control signal. When the main clock enable signal is disabled, the multiplexer 310 selects the output of voltage-maintaining unit 308. The clock generator 38 comprises a controllable oscillator 314. In this embodiment of the invention, the controllable oscillator 314 is a voltage controlled oscillator. The controllable oscillator 314 may generates an original clock signal according to the frequency control signal. The clock generator further comprises a frequency divider 316 which can divide the frequency of the output of the controllable oscillator 314 with a divisor, so that the frequency of the main clock signal and the sub clock signal can both meet the requirement of subordinate device 34. The divisor of the frequency divider 316 can be adjusted according to different system requirements.

In one embodiment of the invention, the main device is a GSM system transceiver, and the subordinate device is a blue-tooth transceiver. In another embodiment of the invention, the subordinate device is a Wi-Fi transceiver such as 802.11a/b/g transceiver. When the GSM system is idle, the frequency control unit is also temporally shut-down to save power. The voltage-maintaining unit 308 keeps the voltage level of the main frequency control signal. When the frequency control circuit 302 shuts-down, the control circuit 36 no longer receives the main frequency control signal. The multiplexer 310 selects the output of the voltage-maintaining unit 308, and sends the maintained voltage into the clock generator 38. The clock generator receives the maintained voltage so that the controllable oscillator able to continuously generates clock signal. When the blue-tooth transceiver 34 is activated, the blue-tooth transceiver 34 can still receive a stable sub clock signal. In this embodiment of the invention, one frequency control unit is shared by a main device and a subordinate device, and the cost is thus reduced.

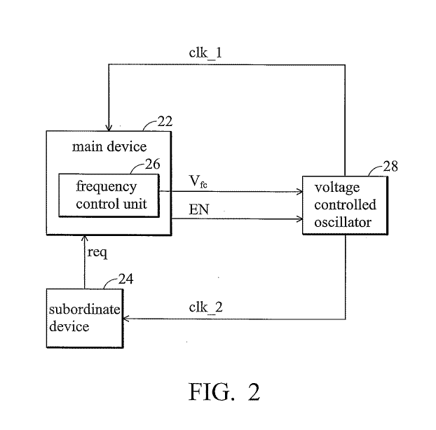

In contrasted to the typical multimode system of FIG. 2, when the main device 22 is idle, the voltage level of frequency control signal is zero, thus the controlled oscillator is not able to generate appropriate sub clock signal. In the invention, however, even the main device is idle, the frequency control signal can still be produced by voltage-maintaining unit 308, and a stable clock frequency is generated accordingly.

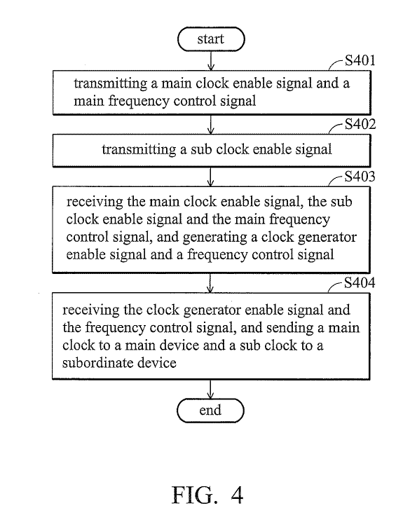

FIG. 4 shows a flowchart of a method for preventing frequency distortion in a multimode system. The multimode system may comprise a main device, a subordinate device, a control circuit, and a clock generator. First, the main device transmits a main clock enable signal and a main frequency control signal in step S401. The subordinate device transmits a sub clock enable signal in step S402. The control circuit receives the main clock enable signal, the sub clock enable signal and the main frequency control signal, and generates a clock generator enable signal and a frequency control signal in step S403. The clock generator receives the clock generator enable signal and the frequency control signal, and sends a main clock to the main device and a sub clock to the subordinate device in step S404.

In this embodiment, when the main device is activated, the frequency control unit is also activated to generate the main frequency control. When the main device is idling and the subordinate device is activated, the control circuit records the voltage level of the main frequency control signal to generate a frequency control signal which has a voltage level similar with the main frequency control signal. Thus, even when the main device is idling and the frequency control unit is temporarily shut-down, a valid frequency control signal is still sent to the clock generator to maintain control of controllable oscillator controlled. In this way, the power consumption of the multimode system is reduced

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A multimode system for preventing frequency distortion, comprising:
a main device issuing a main clock enable signal and a main frequency control signal when activated;
a subordinate device issuing a sub clock enable signal when activated;
a control circuit receiving the main clock enable signal, the sub clock enable signal, and the main frequency control signal, and outputting a clock generator enable signal and a frequency control signal; and
a clock generator receiving the clock generator enable signal and the frequency control signal, and, if activated, outputting a main clock signal to the main device and a sub clock signal to the subordinate device.

2. The multimode system as claimed in claim 1, wherein the control circuit comprises:
an OR gate receiving the main clock enable signal and the sub clock enable signal, and outputting the clock generator enable signal;
a voltage-maintaining unit maintaining the voltage level of the main frequency control signal; and
a multiplexer selecting the main frequency control signal or voltage-maintained signal as the frequency control signal according to the main clock enable signal.

3. The multimode system as claimed in claim 2, wherein the voltage-maintaining unit comprises a resistor in series with a capacitor.

4. The multimode system as claimed in claim 1, wherein the clock generator comprises:
a controllable oscillator generating a original frequency signal upon the frequency control signal;
a frequency divider receiving the original frequency and outputting the main and sub clock signal.

5. The multimode system as claimed in claim 1, wherein the clock control generator generates the main clock signal and the subordinate frequency signal when both the main device and the subordinate device are activated, and the clock control generator generates the sub clock signal when only the subordinated device is activated.

6. The multimode system as claimed in claim 4, wherein the controllable oscillator is a voltage controllable oscillator, and the voltage controllable oscillator generates signals with different frequencies according to the voltage level of the frequency control signal.

7. The multimode system as claimed in claim 1, wherein the main device is a Global System for Mobile Communications (GSM) system.

8. The multimode system as claimed in claim 1, wherein the subordinate device is a blue-tooth transceiver.

9. The multimode system as claimed in claim 1, wherein the subordinate device is an 802.11b/g transceiver.

10. The multimode system as claimed in claim 1, wherein the subordinate device is an 802.11a transceiver.

11. A method for preventing frequency distortion a multimode system which comprises a main device, a subordinate device, a control circuit and a clock generator, comprising:
sending a main clock enable signal and a main frequency control signal when the main device is activated;
sending a sub clock enable signal when the subordinate device is activated;
generating a clock generator enable signal according to the main clock enable signal and the sub clock enable signal, and generating a frequency control signal according to the main clock enable signal and the main frequency control signal by the control circuit; and
generating a main clock signal and generating a sub clock signal according to the clock generator enable signal and the frequency control signal.

12. The method as claimed in claim 11, wherein the main clock signal is generated by a phase-locked loop.

13. The method as claimed in claim 12, further comprising generating the main clock signal and the sub clock signal when the main device and the subordinate device are both activated.

14. The method as claimed in claim 13, further comprising generating the sub clock signal when the main device is idling and the subordinate device is activated.

15. The method as claimed in claim 11, wherein the control circuit comprises:
a voltage-maintaining unit maintaining the voltage level of the main frequency control signal; and
a multiplexer selecting the main frequency control signal or the voltage of the main frequency control signal as the frequency control signal according to the main clock enable signal.

16. The method as claimed in claim 11, wherein the clock generator further comprises a frequency divider to generate signals with a plurality frequencies.
